(19) United States
(12) Patent Application Publication
(10) Pub. No.: US 2014/0067894 A1
(43) Pub. Date: Mar. 6, 2014

(54) OPERATIONS FOR EFFICIENT FLOATING POINT COMPUTATIONS

(71) Applicants: Erich James Plondke, Austin, TX (US); David J. Hoyle, Austin, TX (US); Swaminathan Balasubramanian, Austin, TX (US)

(72) Inventors: Erich James Plondke, Austin, TX (US); David J. Hoyle, Austin, TX (US); Swaminathan Balasubramanian, Austin, TX (US)

(73) Assignee: QUALCOMM INCORPORATED, San Diego, CA (US)

(21) Appl. No.: 13/598,718

(22) Filed: Aug. 30, 2012

(51) Int. Cl. G06F 7/483; G06F 7/44

(52) U.S. Cl. 708/501; 708/495; 708/504

(57) ABSTRACT

Systems and methods for efficiently handling problematic corner cases in floating point operations without raising flags or exceptions. One or more floating point numbers that will generate a problematic corner case in floating point computations, such as division or square root computation, are detected. Fix-up operations are applied to modify the computation such that the problematic corner case is avoided. The modified computation then is performed, while suppressing error flags are suppressed during intermediate stages.

### REFERENCE TO CO-PENDING APPLICATIONS FOR PATENT

The present application for patent is related to the following co-pending U.S. patent applications: “MICROARCHITECTURE FOR FLOATING POINT FUSED MULTIPLY-ADD WITH EXPONENT SCALING” by Liang-Kai Wang, having Attorney Docket No. 121186, filed concurrently herewith, assigned to the assignee hereof, and expressly incorporated by reference herein.

### FIELD OF DISCLOSURE

Disclosed embodiments are directed to specialized instructions and techniques for floating point operations. More particularly, exemplary embodiments are directed to instructions and techniques for detecting and efficiently handling problematic corner cases in floating point operations such as division and square root computations.

### BACKGROUND

Several modern processors support floating point operations and include specialized hardware and/or software for floating point arithmetic. The lack of such support may require software emulation of floating point operations, which can be inefficient and slow. The IEEE Standard for Binary Floating Point Arithmetic, IEEE 754, is portable across processor architectures, and commonly used in processors which implement floating point operations. The standard defines a number system of finite numbers, with a sign, exponent, and fraction part (also known as “mantissa” or “significand”). Implementation of floating point arithmetic operations such as addition, subtraction, multiplication, division, and square root computation may be based on standard definitions. The standard may also define situations which may generate exceptions and cause certain flags to be raised, precision requirements, rounding modes, etc.

With particular regard to division and square root computation, skilled artisans will recognize the required precision, rounding modes, and exceptions associated therewith. One known technique for division includes iterative division, wherein one digit of the final quotient is computed per iteration, which can be very inefficient, and difficult to implement without significant alteration to existing processor architectures. Another, more efficient method of division, the so called Newton-Raphson method, utilizes algorithms that converge to the expected final quotient value. The Newton-Raphson method uses an initial approximation of the reciprocal of the denominator in a floating point division computation, and the algorithm works to converge the reciprocal to 1 divided by the denominator. At the point where the reciprocal of the denominator has achieved sufficient accuracy, multiplying it by the numerator will provide a quotient for the division.

While the Newton-Raphson convergent division method is generally faster and more efficient, certain floating point numbers pose problematic corner cases which require special attention. Such problematic cases include underflows, wherein the final quotient value is too small to be represented in the IEEE 754 standard using the assigned number of bits; overflows, wherein the final quotient value is too large to be represented in the IEEE 754 standard using the assigned number of bits; insufficient precision due to situations like underflows and overflows of intermediate results; and significand values which do not lend themselves well to reciprocal refinement. Other problematic cases involve division by zero, operand values (numerator/denominator) that are infinity or not-a-number (NaN), etc. Problems of a similar nature arise in square root computations as well.

Known techniques for handling such problematic corner cases include detecting corner cases and implementing traps. However, the implementation of traps may involve unwanted complexities. For example, the implementation of traps is similar to software floating point emulation, which is inefficient and slow. Moreover, implementing traps also incurs overheads associated with saving contexts and restoring program execution after the corner cases are dealt with. Trap handlers are also difficult to integrate in the associated processor's pipeline without impacting performance of the rest of the processor's program flow.

Additionally, conventional implementations may also set certain flags during every stage of computation, which may lead to inefficiencies. For example, conventional implementations of Newton-Raphson division may set error flags or floating point flags for conditions relating to lack of precision in intermediate registers for storing values in intermediate stages of computation, even though the theoretically expected final result of the computation may not have raised any such flags. Accordingly, setting such flags in intermediate stages may lead to errors as the flags may have been set incorrectly.

Therefore, there is a corresponding need in the art to overcome the aforementioned drawbacks associated with conventional implementations of floating point operations.

### SUMMARY

Exemplary embodiments of the invention are directed to systems and methods relating to specialized instructions and techniques for detecting and efficiently handling problematic corner cases in floating point operations such as division and square root computations.

For example, an exemplary embodiment is directed to a method of operating a floating point unit, the method comprising: receiving one or more floating point numbers from a memory; receiving a floating point instruction corresponding to a computation; detecting one or more floating point numbers that will generate a problematic corner case in the computation; modifying the computation with a fix-up operation in order to avoid the problematic corner case; suppressing error flags during intermediate stages of the computation; and performing the modified computation.

Another exemplary embodiment is directed to a method of performing a floating point multiply accumulate (FMA) operation, the method comprising: receiving, in a floating point unit, multiplier, multiplicand, and addend operands; detecting that an FMA operation on the operands will generate an exception; defining special conditions for the FMA operation; suppressing error flags during the FMA operation; and performing the FMA operation in the floating point unit according to the special conditions.

Another exemplary embodiment is directed to a method of performing a floating point multiply accumulate operation with scaling (FMASc), the method comprising: receiving, in a floating point unit, multiplier, multiplicand, addend, and scaling factor operands; detecting that an FMASc operation on the operands will generate an exception; defining special conditions for the FMASc operation; suppressing error flags during the FMASc operation; and performing the FMASc operation in the floating point unit according to the special conditions.

Another exemplary embodiment is directed to a floating point unit comprising: logic to receive one or more floating point numbers and a floating point instruction corresponding to a computation; detection logic configured to detect one or more floating point numbers that will generate a problematic corner case in the computation; logic to suppress error flags during intermediate stages of the computation; modification logic configured to modify the computation in order to avoid the problematic corner case; and logic to the execute the modified computation.

Another exemplary embodiment is directed to a system comprising: means for receiving one or more floating point numbers and a floating point instruction corresponding to a computation; means for detecting one or more floating point numbers that will generate a problematic corner case in the computation; means for suppressing error flags during intermediate stages of the computation; means for modifying the computation in order to avoid the problematic corner case; and means for executing the modified computation.

Yet another exemplary embodiment is directed to a non-transitory computer-readable storage medium comprising code, which, when executed by a processor, causes the processor to perform operations for performing a floating point computation, the non-transitory computer-readable storage medium comprising: code for detecting one or more floating point numbers that will generate a problematic corner case in the computation; code for suppressing error flags during intermediate stages of the computation; code for modifying the computation with a fix-up operation in order to avoid the problematic corner case; and code for performing the modified computation.

### BRIEF DESCRIPTION OF THE DRAWINGS

The accompanying drawings are presented to aid in the description of embodiments of the invention and are provided solely for illustration of the embodiments and not limitation thereof.

FIGS. 1A-B illustrate mathematical equations for performing a floating point division operation using the Newton-Raphson method.

FIG. 2 illustrates a graph of coordinate inputs for floating point division.

FIGS. 3A-B illustrate assembly and high-level code sequences for implementing floating point division using the Newton-Raphson method according to exemplary embodiments.

FIG. 4 illustrates mathematical equations for performing a floating point square root computation.

FIGS. 5A-C illustrate assembly and high-level code sequences for implementing floating point square root computation according to exemplary embodiments.

FIG. 6A illustrates an exemplary system 600 configured to perform floating point computations according to exemplary embodiments.

FIG. 6B illustrates a flowchart representation of a method of performing a computation on floating point numbers according to exemplary embodiments.

FIG. 7 illustrates an exemplary wireless communication system 700 in which an embodiment of the disclosure may be advantageously employed.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

Exemplary embodiments include various techniques, special instructions, and associated hardware/software support for overcoming drawbacks of conventional floating point implementations. Some embodiments may include exemplary formats of instructions such as fused multiply add (FMA) with special rounding modes and flag handling in order to implement floating point operations such as division and square root computation. Accordingly, in some embodiments, error flags or other floating point (FP) flags may be suppressed in intermediate stages of computation. Further, some embodiments may also detect problematic corner cases early and use scaling factors to fix-up or move associated operand values into an easily manageable number space, thus obviating the need for traps and exceptions. Some embodiments may include exemplary rounding formats in order to preserve precision of intermediate results and minimize errors in the computation. Some embodiments may also include exemplary handling of special values such as infinity and NaN in order to ensure that floating point operations generate expected results for these values. Yet other embodiments may relate to recognizing sequences of instructions which may be part of divide/square-root implementations and performing fix-up operations on these sequences. These embodiments will now be described in further detail.

### First Embodiment

A first embodiment related to floating point division will now be described. This first embodiment may be configured to include special rounding modes and flag handling in order to avoid errors and problematic corner cases in Newton-Raphson division. As previously mentioned, the well known Newton-Raphson method of division uses an initial approximation of the reciprocal of the denominator. Through a sequence of iterations, the reciprocal is converged to a value of 1 divided by the denominator. Once it is determined that the reciprocal has been calculated with a defined or desired accuracy, the numerator is multiplied by the reciprocal of the denominator in order to generate an estimate of the result (or quotient) of the division. This estimate can be further refined in subsequent iterations until the quotient of specified precision is obtained.

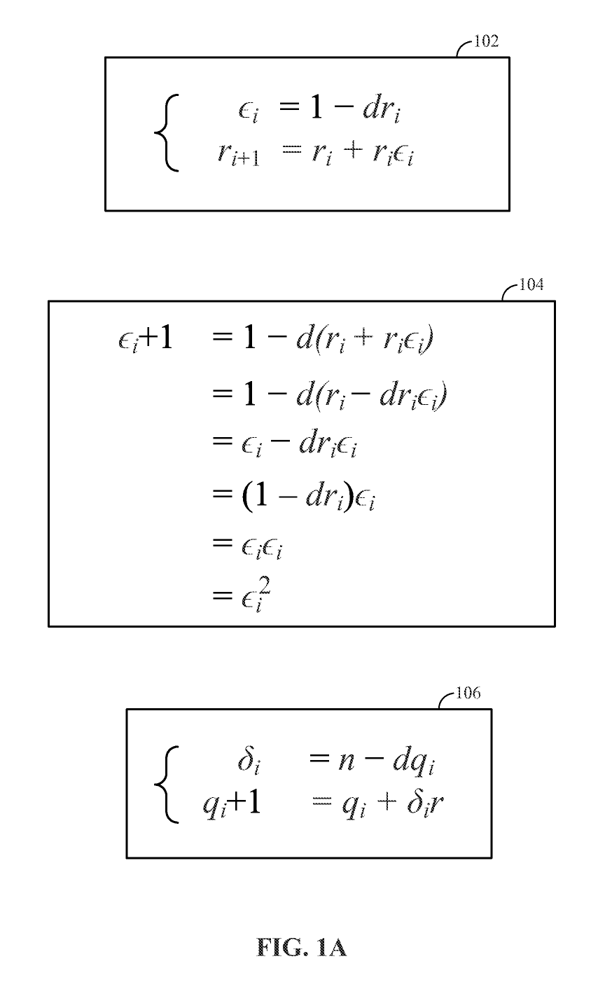

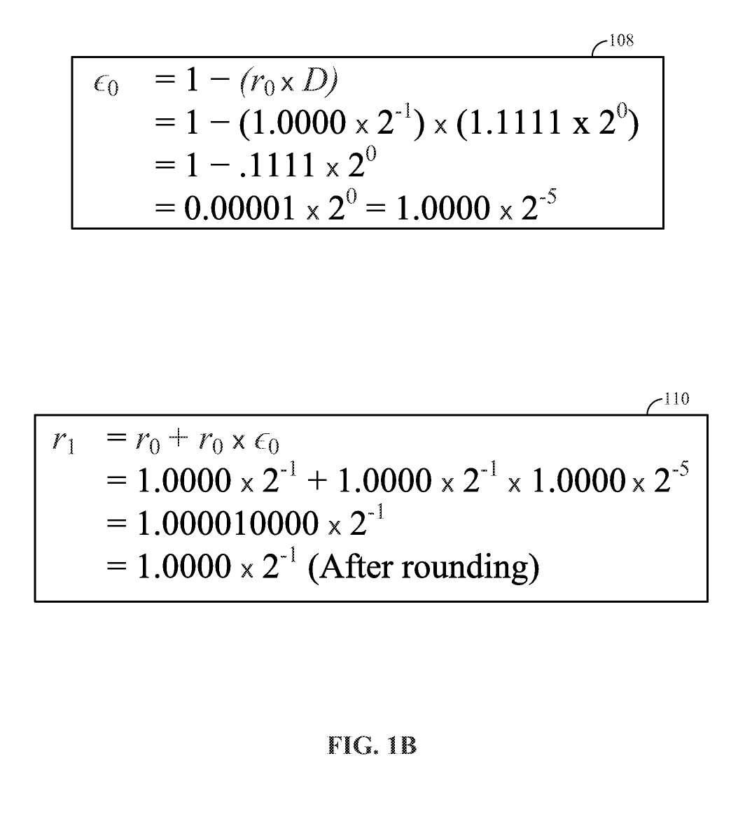

With reference now to FIG. 1A, mathematical equations for division using the Newton-Raphson method are shown. In block 102, a fundamental step of refining the reciprocal estimate is shown, wherein an initial reciprocal estimate, rᵢ is obtained. This initial reciprocal estimate is then multiplied by the denominator d and the product is subtracted from 1 to yield and an initial error term εᵢ. In the next iteration, a more accurate next reciprocal estimate, rᵢ₊₁ is obtained by multiplying the initial reciprocal estimate rᵢ with εᵢ, and adding this product to rᵢ.

Coming to block 104, an improvement to the next error term calculation is illustrated. In some instances, the next estimate for the error term, εᵢ₊₁ can be generated by squaring the reciprocal estimate εᵢ. Because the next error term εᵢ₊₁ calculated in this manner, does not depend on the reciprocal estimate, like in the case of calculation of the error term in block 102, this approach to estimating εᵢ₊₁ can be performed in parallel with computation of the reciprocal estimates, and can thus improve performance.

However, the finite precision of floating point numbers may lead to errors in using the equivalent computation of next error term εᵢ₊₁ per block 104, and the computed εᵢ₊₁ may diverge from to the original computation in block 102. It will be recognized that the convergence of the reciprocal estimate to the defined or desired accuracy is quadratic, because as the error term squares, the number or bits of accuracy of the reciprocal estimate are doubled in each subsequent iteration. As previously noted, the quotient estimate q can be computed by multiplying the finally converged reciprocal r with the numerator n. Because of the limited precision of floating point numbers, this quotient estimate q may not be the accurate.

In the first embodiment, the potential loss of accuracy in the quotient due to limited precision of floating point numbers may be handled by defining an additional error term δ as shown in block 106. An initial value of the error term, δᵢ can be calculated by subtracting the product of the denominator and the quotient estimate from the numerator. Thereafter, subsequent iterations for the quotient, qᵢ₊₁ an be obtained by adding the initially obtained quotient qᵢ to the product of δᵢ and r. It will be recognized that performing the operations defined in blocks 102-106 with round-to-nearest rounding mode may generate a final quotient value which is correct to within half of a unit in the last place (ulp). However, if user-defined rounding mode is used for performing the floating point division, there is a danger of causing errors due to the above described conditions resulting in loss of precision, and related flags may not be set correctly. Accordingly in the first embodiment, an additional iteration of refining the quotient value may be performed, as per block 106, wherein the final multiplication, of δᵢ and r, is performed with rounding in the user-defined rounding mode, whereas all other operations are performed using the round-to-nearest rounding mode. Additionally, the flags may be suppressed during intermediate stages and only the final stage may be allowed to set the flags. In this manner, the first embodiment may overcome drawbacks associated with limited precision of floating point numbers and related potential for loss of accuracy in Newton-Raphson floating point division.

A related embodiment corresponding to a specific value D of the denominator d, and its reciprocal estimate will now be described with reference to FIG. 1B. For the sake of simplicity of illustration of this embodiment, a floating point representation with only four bits of significand is considered. For the specific value D, all four bits of the significand are “1,” and with the floating point notation, 1.1111×2⁰. The correct reciprocal of this denominator value is 16/31 or 1.000010000100001 . . . ×2⁻¹. This reciprocal estimate would be correctly rounded to 1.0001. However, as shown in block 108 of FIG. 1B, the initial reciprocal estimate, r₀, is chosen to be 1.0000×2⁻¹. This value of the initial reciprocal estimate is used for the subsequent iteration for computing the reciprocal estimate in block 110. However, due to the limited number of bits, the intermediate value of subsequent reciprocal estimate rₗ, 1.000010000×2⁻¹, is rounded down to the final value of 1.0000×2⁻¹. Thus, the subsequent reciprocal estimate, r₁, ends up being the same as the initial reciprocal estimate, r₀. This behavior will be retained in subsequent iterations if the intermediate value of the computation is rounded down to fit in the limited four bits available for the significand. Accordingly, the reciprocal estimate will never converge, and thus a problematic corner case arises.

In order to handle this corner case, an embodiment may introduce a step of performing a logical OR of the initial reciprocal estimate r0 with the value “1” in the ulp. The error which will be introduced due to this would be too small to create a significant deviation in the error term ε₀. On the other hand, this step of performing the OR will allow the initial reciprocal estimate to be appropriately rounded such that subsequent reciprocal estimates will converge. Accordingly, in this embodiment, the specific problematic corner case, wherein the denominator d has a significand or mantissa of all 1s, may be efficiently handled by the step of performing a logical OR of the initial reciprocal estimate with the value 1, in order to produce a convergent result without resorting to traps or other exception handling routines.

### Second Embodiment

A second embodiment is associated with detecting problematic operands, such as numerator and denominator values in Newton-Raphson division, and performing fix-up operations in order to perform the division without resorting to conventional traps to handle such cases.

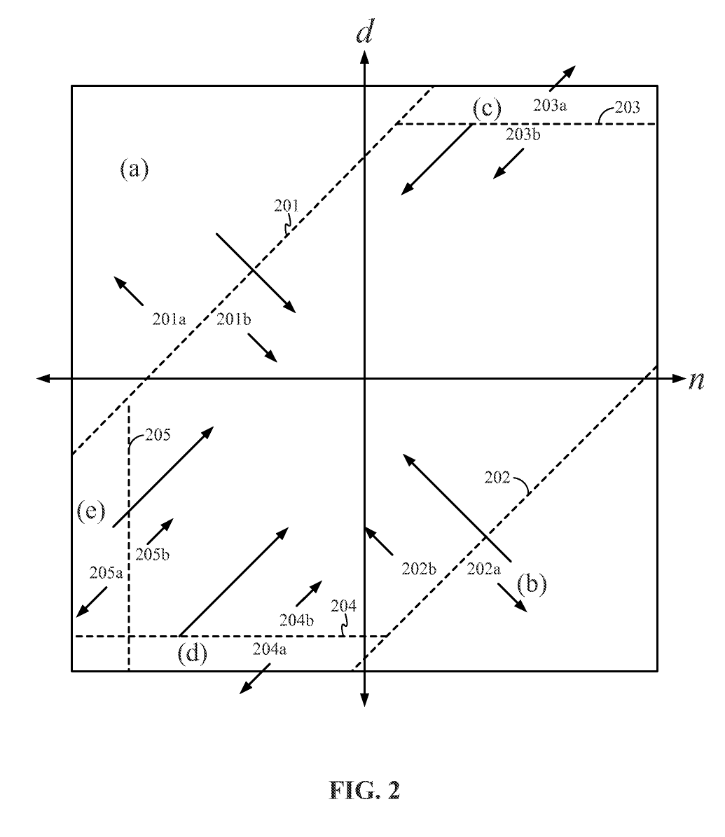

Reference will now be made to FIG. 2, which illustrates scenarios (a)-(e) corresponding to combinations of operand values for floating point division which may be handled in the second embodiment. As illustrated, the range of operand values for numerator n is illustrated on the X-axis, while the range of operand values for denominator d is illustrated on the Y-axis. Scenarios (a)-(e) along with the corresponding fix-up operations according to the second embodiment will now be described.

Starting with scenario (a), this relates to the condition in a division operation wherein the value of the denominator d is large and the value of the numerator n is small, such that the quotient q may be too small to be accurately represented in a given precision or number of bits, for example during above-described computation stages of an iterative Newton-Raphson division. As mentioned previously, this condition may be referred to as an underflow. As illustrated, diagonal 201 represents a dividing line between regions which will yield a quotient with no underflow, generally designated as 201b and regions that will cause an underflow, generally designated as 201a. In order to overcome problems of underflows, any combination of numerator and denominator values that lies in region 201a will need to migrated to region 201b. In the second embodiment, this migration may be accomplished by recognizing numerator and denominator combinations which may yield an underflow (i.e. fall in region 201a) and applying a scaling factor of 2^{k}, wherein k is a positive number, to the numerator n. Additionally, a scaling factor of 2^{-k} is applied to the denominator. An appropriate value of k can be determined based on the value that will be required to scale the numerator n to a scaled value that is large enough to avoid the underflow, thereby migrating the (n, d) coordinates to region 201b. Upon completion of the division operation, the reciprocal of the scaling factor, i.e. 1/(2^{2k}) or 2^{-k} may be applied to the quotient q to ensure the correct quotient value. This will enable intermediate stages of the Newton-Raphson division, for example, to be free of underflow concerns. Accordingly, embodiments may suppress related flags during intermediate stages of the Newton-Raphson division while ensuring that the final result is free of errors.

Coming now to scenario (b), this relates to overflow, wherein the value of the numerator n is large and the value of the denominator d is small, such that the quotient q may be too large to be accurately represented in the limited precision, for example during above-described computation stages of an iterative Newton-Raphson division. With reference to FIG. 2, diagonal 202 may represent the dividing line between region 202a which may cause an overflow, and region 202b which may be safe from overflow conditions. Accordingly, in this case, the second embodiment may detect that particular (n, d) coordinates lie in region 202a, and apply a scaling factor of 2^{k} to the denominator d, and a scaling factor of 2^{-k} to the numerator n, in order to migrate the (n, d) coordinates to region 202b. The reciprocal scaling factor, 2^{2k} may be applied to the final quotient q to ensure the correct quotient value. This will enable intermediate stages of the Newton-Raphson division, for example, to be free of overflow concerns. Accordingly, embodiments may suppress related flags during intermediate stages of the Newton-Raphson division while ensuring that the final result is free of errors.

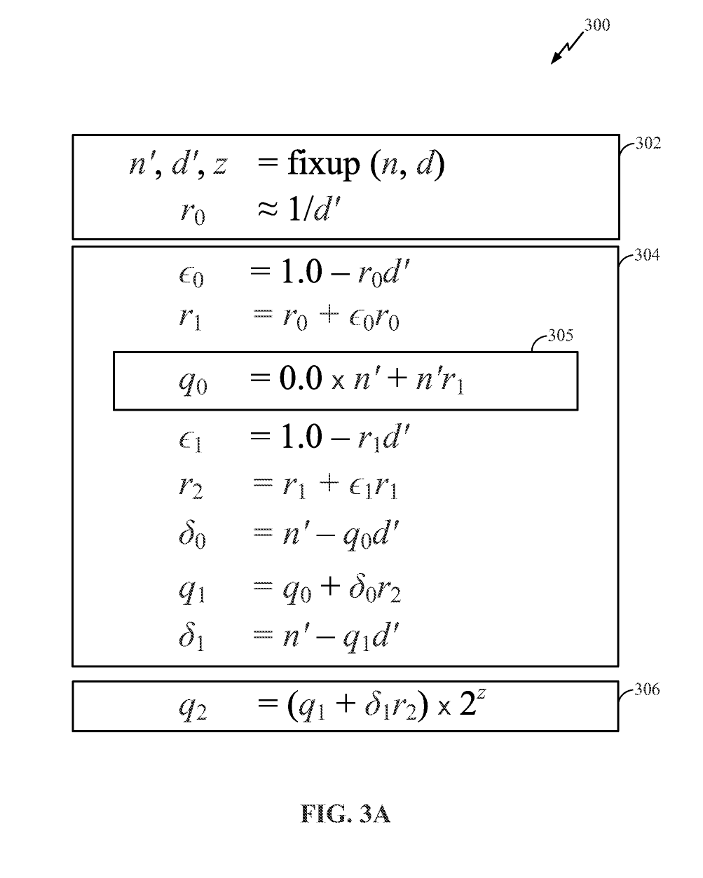

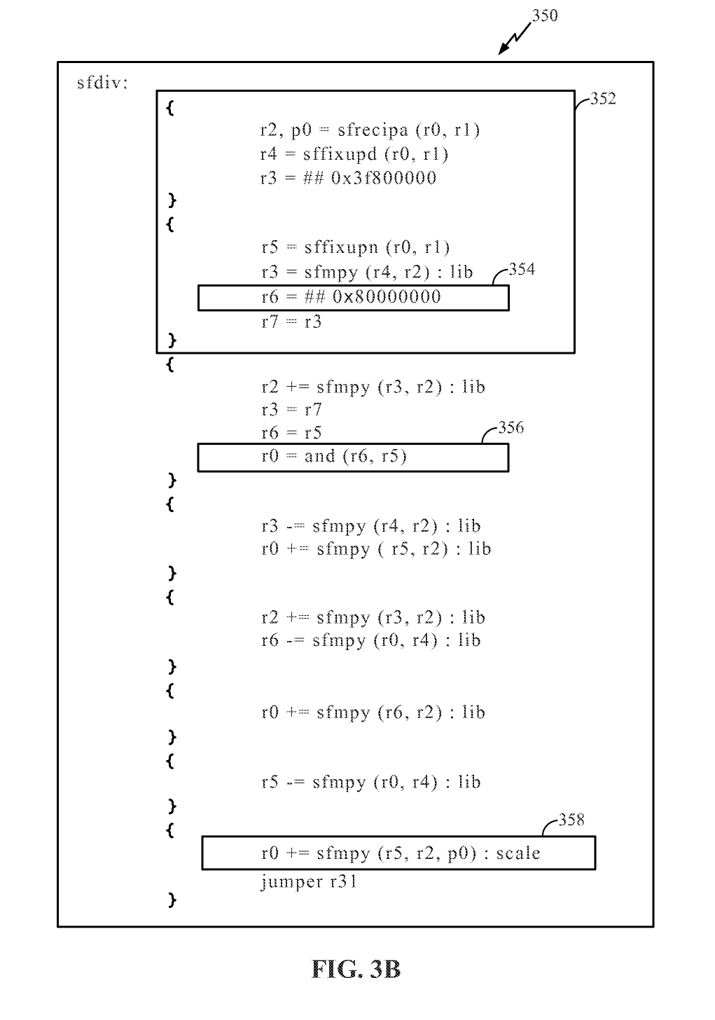

Moving on to scenario (c), this relates to situations similar to scenario (a), with the difference that scenario (c) may generally apply to very large denominator d values, regardless of the size of the numerator n. Accordingly, scenario (c) may be represented by varying values of the numerator for the denominator value larger than a particular large value. In FIG. 3, horizontal line 203 forms the dividing line between region 203a which designates large denominator values which will result in a lack of precision in the quotient, and region 203b which designates denominator values which may not cause loss of precision. In order to migrate the (n, d) coordinates from region 203a to region 203b, the second embodiment may detect values of the denominator d which fall in region 203a and multiply both the numerator n and denominator d by the same amount, for example, scaling factor 2^{k}, wherein k is a negative number, with the recognition that 2^{k}/2^{k}=1, and thus the value of the final quotient would remain unaltered. Accordingly, embodiments may suppress related flags during intermediate stages of the Newton-Raphson division while ensuring that the final result is free of errors.

Scenario (d) is similar to scenario (c) with the difference that straight line 204 represents the dividing line between region 204a which may cause insufficient precision due to an overflow type result because of a very small denominator value and region 204b which would have sufficient precision. Similar to scenario (d), the second embodiment may apply the same scaling factor 2^{k}, wherein k is a positive number, to both the numerator n and the denominator d, to migrate the coordinates (n, d) into from region 204a to region 204b. Accordingly, embodiments may suppress related flags during intermediate stages of the Newton-Raphson division while ensuring that the final result is free of errors.

The converse of scenario (d) is scenario (e) wherein the numerator n is too small, but with the same result that the quotient is too small to be represented with sufficient precision in the given number of bits. Straight line 205 represents the dividing line between region 205a which may cause loss of precision and region 205b which represents sufficient precision. Accordingly, the second embodiment may migrate (n, d) coordinates from problematic region 205a to region 205b by applying the same scaling factor 2^{k} to numerator n and denominator d. Accordingly, embodiments may suppress related flags during intermediate stages of the Newton-Raphson division while ensuring that the final result is free of errors.

The above-described scenarios (a)-(e) may involve applying scaling factors to operands of a floating point division operation. As previously described, for example, with regard to the first embodiment, several multiplication and addition (or subtraction) operations are performed during the iterative computation of a quotient value of desired precision in implementing the Newton-Raphson division. In order to efficiently implement the various scaling and multiplication and addition operations, some embodiments may involve a special instruction of the form, fused multiply-add with scaling, also known as FMASc. The FMASc instruction can be denoted as [(A*B)+C]*2^{k}, and defines the fused multiply-add operation on multiplicand A, multiplier B, and addend C, with a scaling factor 2^{k} applied to the result. Customized hardware implementations of the FMASc instruction are described in the above-referenced co-pending application. Special handling of the FMA instruction is also described in the following embodiments.

### Third Embodiment

A third embodiment relates to special handling of flags and rounding modes in floating point operations such as division and square-root computation. In order to introduce this embodiment, a simple numerical example will be considered. In the case of a floating point division of the value “3” with the “3” performed using the Newton-Raphson method, the reciprocal estimates may suffer from loss of precision because the exact value of 1/3 cannot be represented in a finite number of bits. However, the final quotient q must still be the value “1.0” and the division 3/3 should not raise any flags (e.g. the “Inexact” flag defined in the IEEE 754 standard). Accordingly, embodiments may suppress such flags during intermediate stages of computation in order to avoid the above problems associated with erroneous flag setting. Additionally, in order to efficiently handle several other problematic corner cases, the third embodiment can also include the following special behaviors.

With regard to a floating point division, the following special handling is defined. Firstly, a not-a-number (“NaN,” as defined in the IEEE 754 standard) operand value, for example, for the denominator, is defined to result in a NaN reciprocal estimate. This causes the final quotient to be correctly computed as a NaN result. Similar definition is extended to operand values for divisions, 0/0 and ∞/∞, to generate a NaN reciprocal estimate and subsequently, a NaN result.

Secondly, special fix-up operations are performed on finite division by zero, as well as, division of an infinity (numerator is ∞) by a non-zero finite value. In these cases, the numerator is fixed up to be ∞ and the denominator is fixed up to be 1. The reciprocal estimate of the denominator is also fixed up to be 1, such that the final result is ∞.

Thirdly, division of zero by a nonzero value as well as a finite value divided by infinity also involves special handling. The IEEE 754 format specifies that in these cases, the quotient of the division must be zero, and further, the zero must be of the correct sign. More specifically, where n is a positive value, the division +n/∞ is defined to result in +0, while the division −n/∞ is defined to result in −0. However, the IEEE standard also specifies that the addition of −0 and −0 should result in +0. This requirement may be problematic for many conventional FMA operations with a resulting value 0 as they would all be forced to have a sign +0. Accordingly, in contrast to conventional FMA implementations, this embodiment defines special behavior of FMA operations for computing [(A*B)+C], wherein the sign of the addend C is retained if either the multiplicand A or the multiplier B is zero. With this special behavior in this embodiment, when the quotient value in Newton-Raphson division (e.g. in block 106 of FIG. 1) is initialized with the correctly-signed zero, the result is guaranteed to yield the correctly signed zero. FMA operations with this special behavior may also be similarly extended to square root computations in exemplary embodiments.

### Fourth Embodiment

A fourth embodiment relates to organization of instruction sequences and related fix-up operations for floating point Newton-Raphson division. With reference to FIG. 3A, an exemplary assembly code sequence 300 for implementing floating point division according to the Newton-Raphson method is illustrated. In block 302, it is recognized that numerator n and denominator d require fix-up operations similar to the fix-up operations described in the previous embodiments. In one example, the fix-up operation may relate to specific values of n and d which may require migration of (n, d) coordinates by appropriate scaling according to one of scenarios (a)-(e) described in the second embodiment. Thus, fixed up numerator n′ and denominator d′ are obtained and an initial reciprocal estimate r₀ is based on d′. In block 304, two iterations of computing subsequent reciprocal estimates r₁ and r₂, and corresponding error terms ε₀, and εₗ are calculated. As described in the first embodiment, additional iterations for the quotient, q₀, q₁, and q₂ using error terms δ₀ and δ₁ are performed in order to accommodate user defined rounding modes and avoid errors due to loss of accuracy/lack of convergence. Accordingly, block 304 may be performed using round-to-nearest rounding mode, without setting any flags (such as the previously discussed Inexact flag). In the final step, block 306, a user-defined rounding mode can be accommodated and flags may be set. In this manner, intermediate computation stages may carry on uninterrupted by suppressing flags, and yet the final step can accomplish desired rounding and set any flags as needed.

It will be noted that all operations in code sequence 300 may be performed with correct handling of the sign of zeros. Particularly, in the highlighted line of code 305, a fix-up according to the third embodiment is illustrated. Therein, the computation of 0.0×n′ is required to have a correctly-signed zero result and therefore, can be implemented using an AND function to clear all bits of n′ except for its most significant (sign) bit. It will be appreciated that this fix-up may reuse the same registers and formatting requirements as integer registers and no extra hardware support is required.

Referring now to FIG. 3B, an exemplary high-level code sequence 350 is illustrated for an equivalent single precision floating point division, as code sequence 300 of FIG. 3A. In high-level code sequence 350, fix-up operations are shown in block 352. Highlighted lines of code 354 and 356 illustrate fix-up operations related to correctly signed zeros, and more particularly, using integer AND functions to initialize values with negative zero (−0) when the numerator is negative. Highlighted line of code 358 illustrates the above described floating point FMA operation with scaling (FMASc) in order to accommodate a scaling factor of 2^{2k} or 2^{-2k}, based on the particular fix-ups, for example in one of scenarios (a)-(e) of the second embodiment.

The disclosed embodiments can be efficiently implemented in a multi-threaded processor architecture. With multiple threads of execution, two or more division operations can be executed in parallel. With suppression of flags in intermediate stages and special handling of rounding modes, the execution may be expedited. While the description has focused on IEEE 754 single precision floating point numbers, the disclosed techniques can be easily extended to the more computationally intensive double precision floating point numbers as well.

### Fifth Embodiment

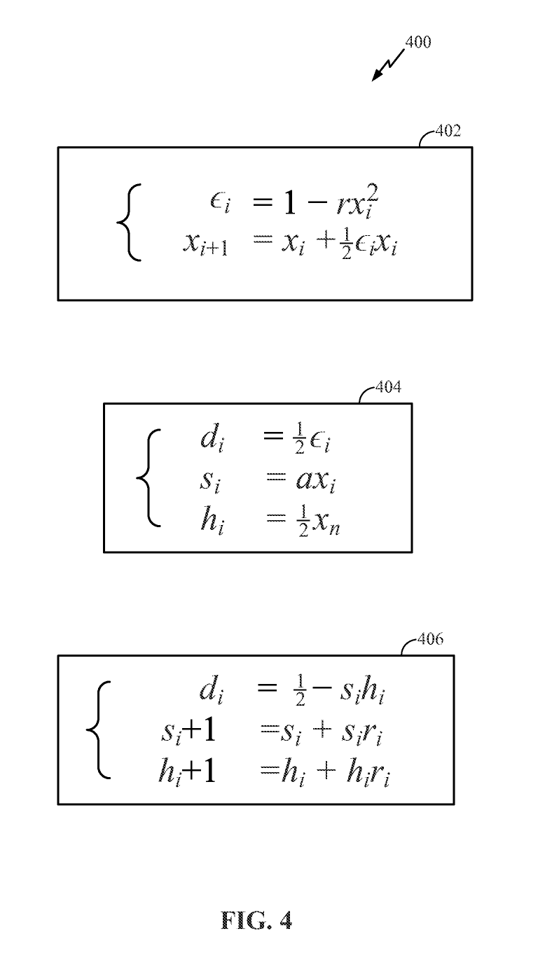

Coming now to a fifth embodiment, disclosed techniques can be applied to floating point square root computations in similar manner as discussed above for division. The square root computations may also follow the Newton-Raphson approach, relevant aspects of which will be discussed below in reference to FIG. 4. Initially, an inverse square root x of the input operand, radicand r (i.e. the value under the radical, upon which the square root computation is performed), is computed recursively. In block 402, computation of the error term εᵢ according to the formula (1−rxᵢ²) cannot be performed in a single FMA instruction. However, it is desirable, for higher performance, to be able to perform this calculation of the error term εᵢ in a single FMA instruction. In order to accomplish this, the fifth embodiment can include the definitions of the terms dᵢ, sᵢ, and hᵢ in block 404. Using these definitions of block 404, subsequent values of these terms are iteratively computed using single FMA instructions in block 406. After sufficient number of such iterations of block 406, the hᵢ term converges to a value that is equal to half of the inverse square root of radicand r, and the term sᵢ converges to the square root of the radicand r. In this embodiment, a fix-up operation may be employed by using the error term εᵢ from block 402 to obtain the correct result for all rounding modes. Additionally, in this embodiment may also suppress flags during intermediate stages of computation.

### Sixth Embodiment

Similar to the migration of (n, d) coordinates described in the second embodiment for division, a sixth embodiment can relate to migration of the radicand value for square root computation. Because there is only one input operand for square root computation, only one scenario relating to problematic cases requiring migration will be discussed. This scenario relates to the radicand r being too small, which may lead to inexact intermediate values during the intermediate stages of computation, for example in block 406. In order to efficiently handle this situation, the sixth embodiment can fix-up such problematic radicand values by applying a scaling factor of 2^{k} to the radicand, wherein k is a positive number and the square root computation is performed on the fixed up radicand with the scaling factor applied, i.e. on r2^{k}. Once the final result is obtained, it can be scaled by 2^{k/2} in order to cancel out the effect of the scaling factor. Accordingly, related flags may be suppressed during intermediate stages of computation.

### Seventh Embodiment

Similar to the third embodiment with regard to division, a seventh embodiment relates to problematic special values with regard to square root computation, and related special handling and flag suppression during intermediate stages. Firstly, a NaN radicand can be defined to produce a NaN result, and secondly a negative nonzero radicand can be defined to generate a NaN result. Thirdly, a zero radicand can be defined to produce a zero result of the same sign as the radicand. Fourthly, a radicand that is positive infinity can be defined to produce a positive infinity result.

Referring now to exemplary code sequence 500, assembly code for performing a square root computation is illustrated. Similar to the case of division, zero radicands are handled like zero numerators for division. The radicand remains unchanged at a zero value during the computation, but the reciprocal estimate of the radicand is 1.0. With reference to block 502, in the case of a radicand that is positive infinity, the reciprocal estimate as well as the radicand is fixed up to negative infinity. In this manner, the value of the radicand can pass through the computation to arrive at the reciprocal estimate without generating a NaN, and thus generate a correct result of positive infinity. Accordingly, the square root computation in this embodiment can begin with an initial reciprocal square root estimate, x₀, and a correspondingly fixed-up radicand, r′. In the case where the radicand is positive infinity, both x₀ and r′ can be fixed up to negative infinity.

Proceeding to code line 504, s₀ will be positive infinity, as it is the product of two negative infinities, x₀ and r′. In code line 506, h₀ will take on the value of negative infinity. In general, the multiplication by ½ in code line 506 can be performed by decrementing the exponent field of x₀ using for example, a scalar add instruction. It is also known in this code sequence that x₀ will be significantly far away from the denormal boundary, and hence related exceptions will not arise. Proceeding to code line 508, d₀ becomes positive infinity, because it is obtained from the subtraction of two infinities of opposite sign from a finite value. As the code sequence 500 traverses through subsequent iterations, for example, in block 510 for subsequent iterations of sᵢ, the values of sᵢ continue to remain positive infinities, and the need for adding infinities of opposite signs which would result in a NaN is eliminated. Accordingly, flags may be suppressed during the intermediate stages of computation as the code sequence 500 proceeds through the iterations.

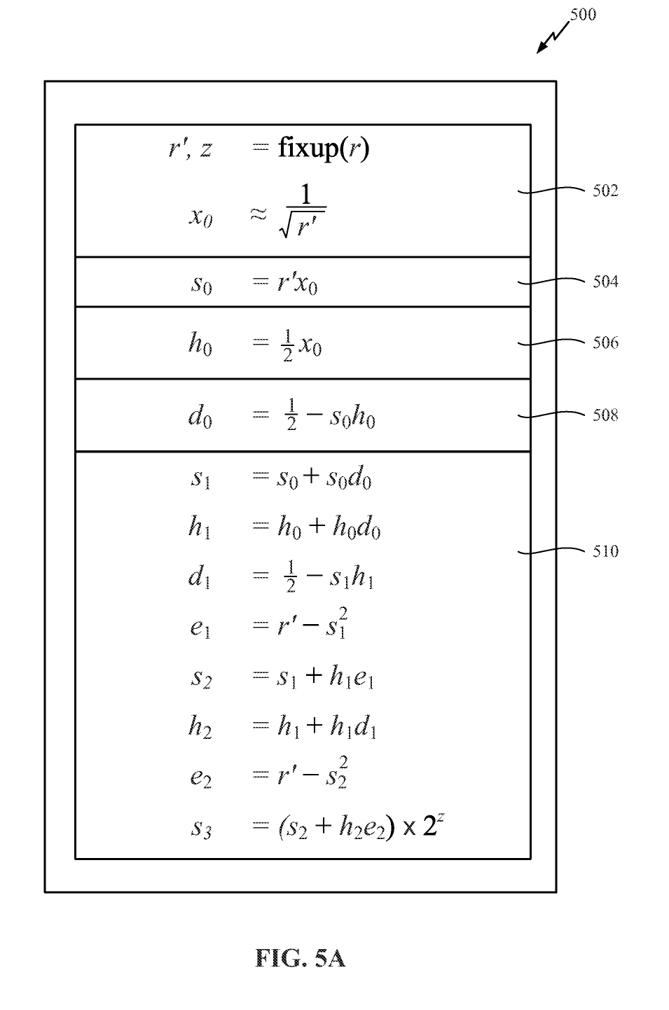

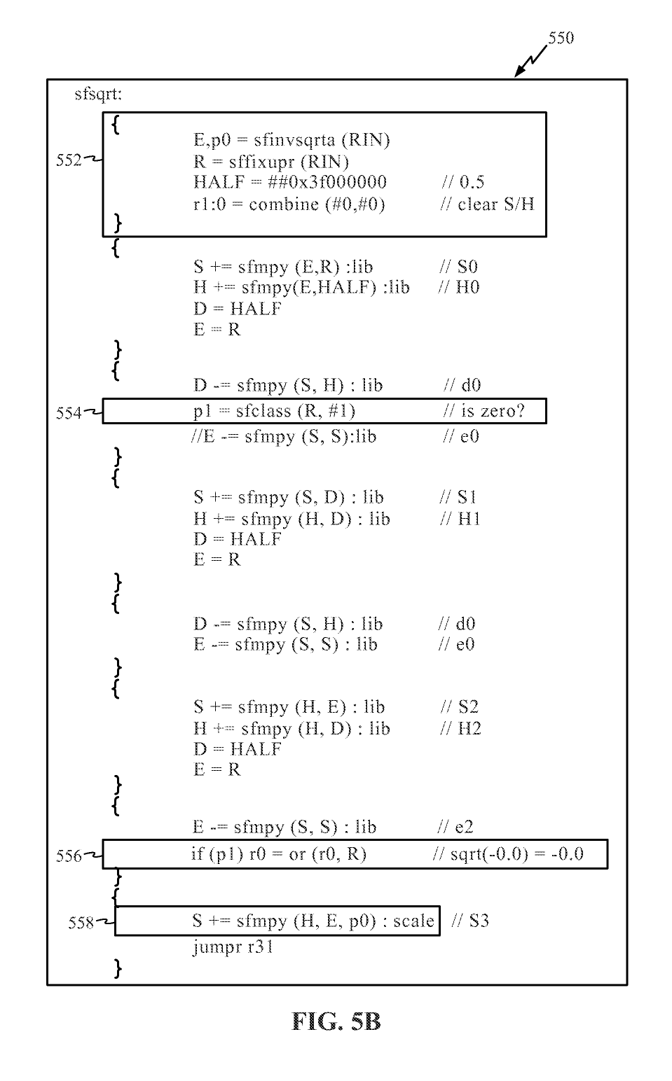

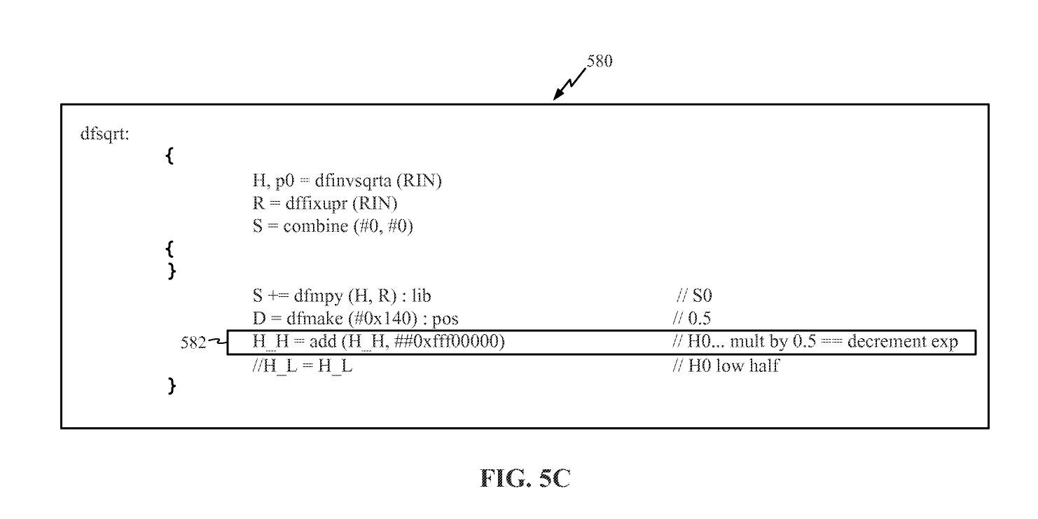

Referring now to FIG. 5B, a high-level code sequence 550 is illustrated for performing single precision square root computations according to an exemplary embodiment. As shown in block 552, fix-up operations as described above in code sequence 500, are illustrated. Highlighted code lines 554 and 556 illustrate implementing a conditional OR operation in order to correct a −0 case. Highlighted line of code 558 illustrates the above described floating point FMA operation with scaling (FMASc) in order to accommodate a scaling factor of 2^{k/2} or 2^{-k/2}, based on the particular fix-ups, for example, as described in the sixth embodiment.

With reference to FIG. 5C, an exemplary code sequence 580 is illustrated for performing double precision square root computations (i.e. radicand is a double precision number, as defined in the IEEE 754 standard). As shown in highlighted line of code 582, the multiplication of ½ is implemented by using an integer add operation, as discussed above in code line 506 of code sequence 500.

In the above describe embodiments for division and square root computations, the reciprocal and reciprocal square root estimates can be obtained by straightforward addition (followed by a division by 2 in the case of square roots). In order to arrive at an accurate significand for these estimates, a small lookup table can be employed, wherein the lookup table can be indexed by the significand of the number for which the estimate is desired (e.g. denominator or radicand), and the significand of the estimate can be returned. In one embodiment, N evenly-spaced values lying between 1 and 2 can be used for generating the lookup table for reciprocal estimates, while similarly, evenly-spaced values between 1 and 4 can be used for reciprocal square root estimates. The accuracy of these tables can be increased if the tables are adjusted to be the approximation of the half-bit greater than the index (significand of the denominator or radicand). For the case of square roots, the least significant bit of the exponent can be used to index into the table, along with a few bits of the significand, in some embodiments.

Exemplary embodiments can implement rounding before the lookup, thus enabling increased control over problematic values, such as the all 1s significand for division that was discussed in the first embodiment. Thus, the reciprocal estimate can be the correctly-rounded value, which can be represented as 2ⁿ+1 ulp. In some embodiments, special instructions can be included to specify an accuracy or approximation tolerance, such that a reciprocal estimate can be obtained with the specified accuracy.

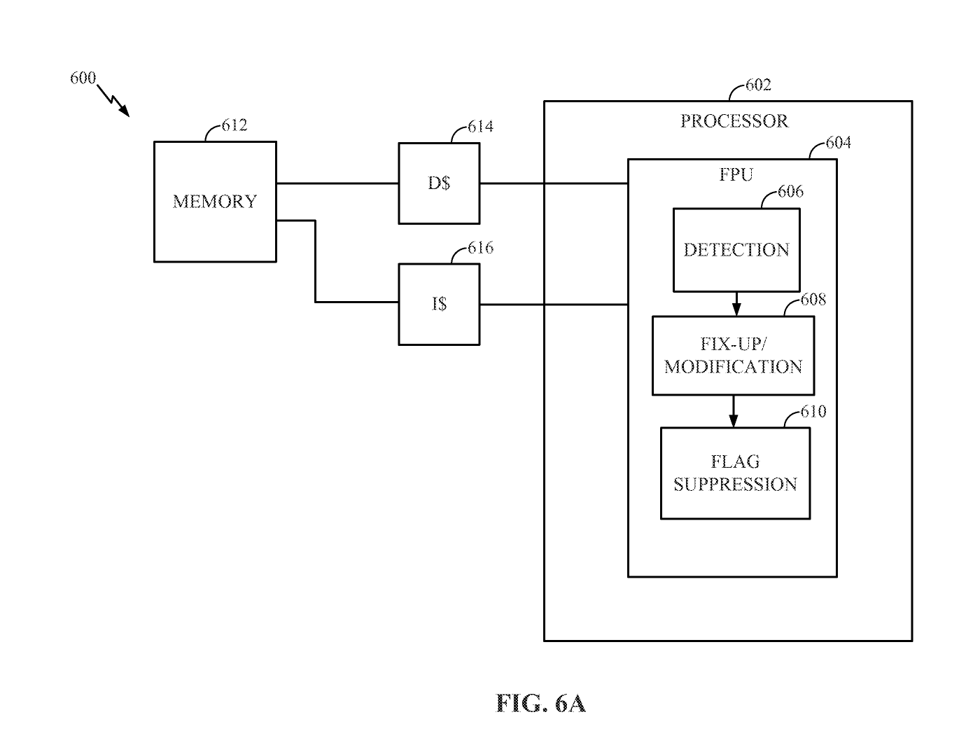

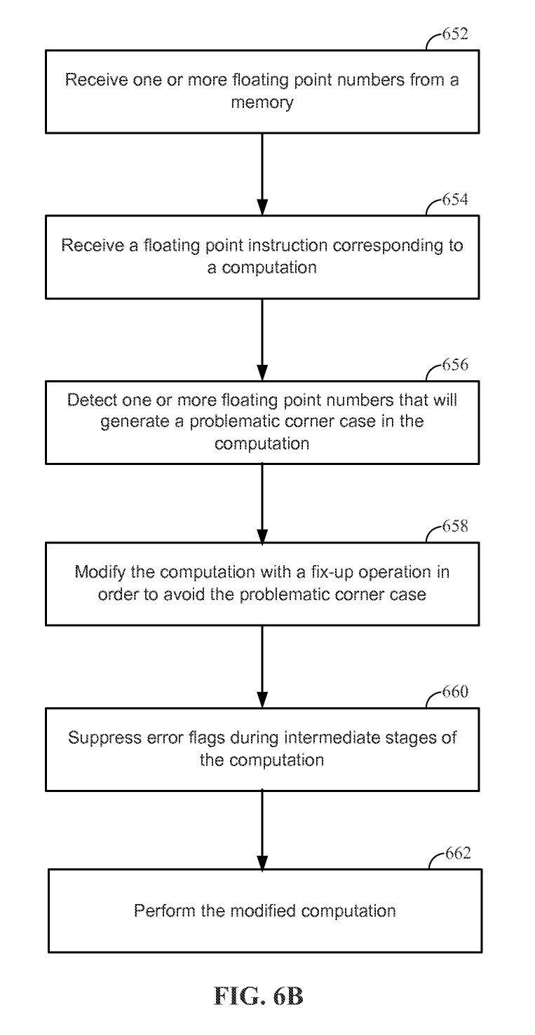

With reference now to FIG. 6A, it will be appreciated that the various embodiments described above can be implemented in the illustrated system 600. System 600 includes exemplary hardware blocks designed to perform the various floating point operations, such as the fix-up operations that have been described above. For example, system 600 may include memory 612 configured to store instructions and data. Data, cache (D$) 614 coupled to memory 612 may store floating point numbers to be used in exemplary floating point operations, while instruction cache (I$) 616 may include instructions corresponding to exemplary floating point computations. Floating point unit (FPU) 604 may be implemented as a dedicated hardware block within processor 602, without loss of generality. System 600 will now be further explained with regard to an exemplary floating point computation.

Considering a Newton-Raphson division, for example, according to the first and second embodiments, I$ 616 may be configured to store related instructions, such as a sequence of instructions for floating point division. D$ 614 may be configured to store the floating point numerator n and denominator d values corresponding to the floating point division instruction. One or more registers in a register file (not shown) may also be configured to store numerator n and denominator d values. An execution pipeline in processor 602 may be configured to read the floating point division instruction and corresponding numerator n and denominator d, and initiate the computation in an execution stage of the execution pipeline by invoking FPU 604. Detection logic 606 may be configured to first detect whether the numerator n and denominator d may give rise to a problematic corner case (e.g. per scenarios (a)-(e) as illustrated in FIG. 2). If detection logic 606 finds that a problematic corner case may arise, then fix-up/modification logic 608 may be configured to one of the above-described fix-up/modification operations (e.g. apply a scaling factor to migrate (n, d) co-ordinates, as discussed with respect to FIG. 2).

The floating point unit may then be supplied with the fixed-up/modified numerator n and denominator d to proceed with the division operation, for example, according to exemplary techniques described above. In some embodiments, this modified division operation using the fixed-up/modified numerator in and denominator d may be executed based on additional instructions or sequence of instructions which may be received, for example, from I$ 616. Additionally, flag suppression logic 610 may also be invoked to suppress any flags during intermediate stages of the computation, while allowing the flags to be set only in a final stage wherein the final result/quotient of the Newton-Raphson division becomes available. One of ordinary skill in the art will recognize suitable variations to system 600 to implement the various exemplary embodiments described above.

It will also be appreciated that embodiments include various methods for performing the processes, functions and/or algorithms disclosed herein. For example, as illustrated in FIG. 6B, an embodiment can include a method of operating a floating point unit (e.g. FPU 604), the method comprising: receiving one or more floating point numbers (e.g. numerator n and denominator d from a memory (e.g. D$ 614/memory 612)—Block 652; receiving a floating point instruction (e.g. from I$ 616/memory 612) corresponding to a computation (e.g. Newton-Raphson division)—Block 654; detecting one or more floating point numbers that will generate a problematic corner case (e.g. in detection logic 606) in the computation—Block 656; modifying (e.g. in fix-up/modification block 608) the computation with a fix-up operation in order to avoid the problematic corner case-Block 658; suppressing flags during intermediate stages of the computation (e.g. by using flag suppression logic 610)—Block 660; and performing the modified computation (e.g. in FPU 604)—Block 662.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

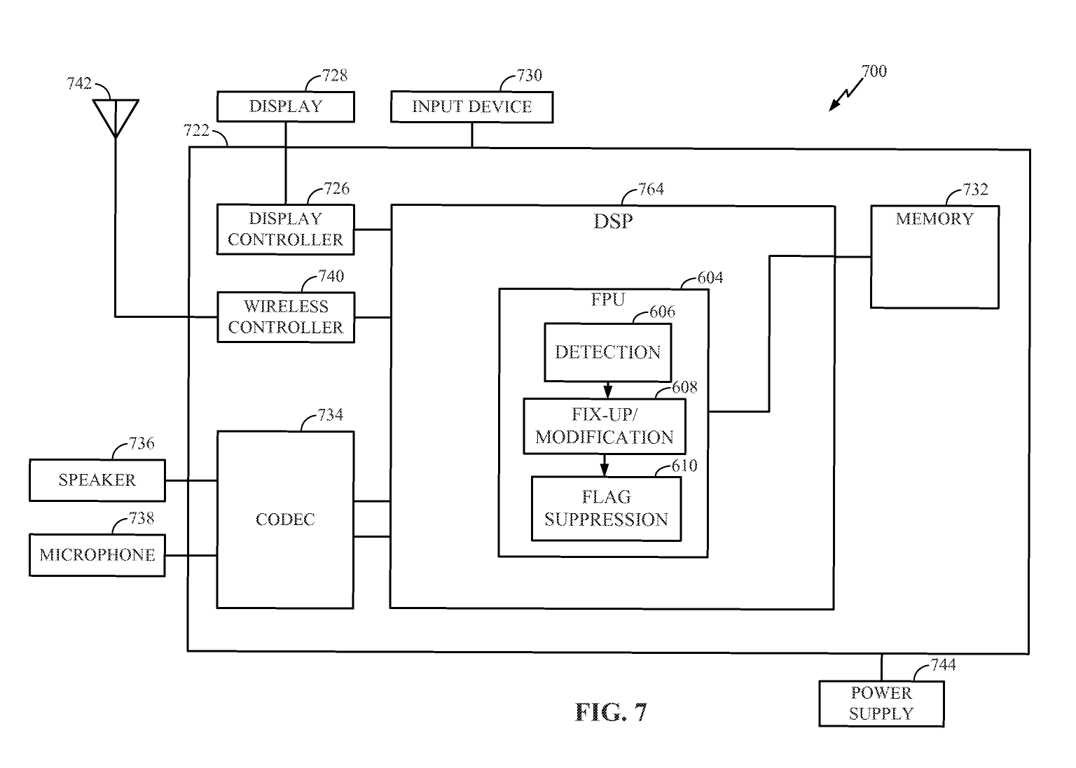

Referring to FIG. 7, a block diagram of a particular illustrative embodiment of a wireless device that includes a multi-core processor configured according to exemplary embodiments is depicted and generally designated 700. The device 700 includes a digital signal processor (DSP) 764 which may include floating point unit 604 described above, wherein floating point unit 604 may further include detection logic 606, fix-up/modification logic 608, and flag suppression logic 610. DSP 764 may be coupled to memory 732, wherein similar to memory 612, memory 732 may be configured to store floating point numbers and/or instructions for operation by floating point unit 604. FIG. 7 also shows display controller 726 that is coupled to DSP 764 and to display 728. Coder/decoder (CODEC) 734 (e.g., an audio and/or voice CODEC) can be coupled to DSP 764. Other components, such as wireless controller 740 (which may include a modem) are also illustrated. Speaker 736 and microphone 738 can be coupled to CODEC 734. FIG. 7 also indicates that wireless controller 740 can be coupled to wireless antenna 742. In a particular embodiment, DSP 764, display controller 726, memory 732, CODEC 734, and wireless controller 740 are included in a system-in-package or system-on-chip device 722.

In a particular embodiment, input device 730 and power supply 744 are coupled to the system-on-chip device 722. Moreover, in a particular embodiment, as illustrated in FIG. 7, display 728, input device 730, speaker 736, microphone 738, wireless antenna 742, and power supply 744 are external to the system-on-chip device 722. However, each of display 728, input device 730, speaker 736, microphone 738, wireless antenna 742, and power supply 744 can be coupled to a component of the system-on-chip device 722, such as an interface or a controller.

It should be noted that although FIG. 7 depicts a wireless communications device, DSP 764 and memory 732 may also be integrated into a set-top box, a music player, a video player, an entertainment unit, a navigation device, a personal digital assistant (PDA), a fixed location data unit, or a computer. A processor (e.g., DSP 764) may also be integrated into such a device.

Accordingly, an embodiment of the invention can include a computer readable media embodying a method for performing a divide/square-root computation on floating point numbers. Accordingly, the invention is not limited to illustrated examples and any means for performing the functionality described herein are included in embodiments of the invention.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of operating a floating point unit, the method comprising:
receiving one or more floating point numbers from a memory;
receiving one or more floating point instructions corresponding to a computation;
detecting one or more floating point numbers that will generate a problematic corner case in the computation;
modifying the computation with a fix-up operation in order to avoid the problematic corner case;
suppressing error flags during intermediate stages of the computation; and
performing the modified computation.

2. The method of claim 1, wherein the computation is Newton-Raphson division comprising two or more iterative stages, and the problematic corner case corresponds to loss of precision in rounding during intermediate stages, and wherein the fix-up operation comprises applying a round-to-nearest rounding on each of the iterative stages except for a final stage and applying a user-defined rounding in the final stage.

3. The method of claim 1, wherein the computation is Newton-Raphson division of a numerator by a denominator, wherein a binary representation of a mantissa of the denominator consists of all 1s, wherein the problematic corner case corresponds to a lack of convergence of the Newton-Raphson division to a correct quotient, and wherein the fix-up operation comprises performing a logical OR of an initial reciprocal estimate of the denominator for use in the Newton-Raphson division.

4. The method of claim 1, wherein the computation is Newton-Raphson division of a numerator by a denominator, wherein the problematic corner case corresponds to an expected underflow in the quotient of the Newton-Raphson division, and wherein the fix-up operation comprises applying a scaling factor of 2^{k} to the numerator and 2^{-k} to the denominator, wherein k is a positive number.

5. The method of claim 4, further comprising applying a scaling factor of 2^{-2k} to the quotient of the Newton-Raphson division.

6. The method of claim 1, wherein the computation is Newton-Raphson division of a numerator by a denominator, wherein the problematic corner case corresponds to an expected overflow in the quotient of the Newton-Raphson division, and wherein the fix-up operation comprises applying a scaling factor of 2^{-k} to the numerator and 2^{k} to the denominator, wherein k is a positive number.

7. The method of claim 6, further comprising applying a scaling factor of 2^{2k} to the quotient of the Newton-Raphson division.

8. The method of claim 1, wherein the computation is Newton-Raphson division of a numerator by a denominator, wherein the problematic corner case corresponds to a large denominator value causing an expected loss of precision in the quotient of the Newton-Raphson division, and wherein the fix-up operation comprises applying a scaling factor of 2^{k} to both the numerator and the denominator, wherein k is a negative number.

9. The method of claim 1, wherein the computation is Newton-Raphson division of a numerator by a denominator, wherein the problematic corner case corresponds to a small denominator value causing an expected loss of precision in the quotient of the Newton-Raphson division, and wherein the fix-up operation comprises applying a scaling factor of 2^{k} to both the numerator and the denominator, wherein k is a positive number.

10. The method of claim 1, wherein the computation is Newton-Raphson division of a numerator by a denominator, wherein the problematic corner case corresponds to a small numerator value causing an expected loss of precision in the quotient of the Newton-Raphson division, and wherein the fix-up operation comprises applying a scaling factor of 2^{k} to both the numerator and the denominator, wherein k is a positive number.

11. The method of claim 1, wherein the computation is Newton-Raphson division of a numerator by a denominator, the Newton-Raphson division comprising two or more iterative stages, wherein the problematic corner case corresponds to one of an overflow, underflow, or expected loss of precision in the quotient of the Newton-Raphson division, and wherein the fix-up operation comprises applying a scaling factor to at least one of the numerator or the denominator by implementing a fused multiply and add with scaling (FMASc) instruction in at least one of the iterative stages.

12. The method of claim 1, wherein the computation is Newton-Raphson division of a numerator by a denominator, the Newton-Raphson division comprising two or more iterative stages, wherein the problematic corner case corresponds to the denominator being not-a-number (NaN), and the fix-up operation comprises setting a reciprocal estimate of the denominator to be NaN in a first iterative stage such that the quotient of the Newton-Raphson division is computed as NaN.

13. The method of claim 1, wherein the computation is Newton-Raphson division of a numerator by a denominator, the Newton-Raphson division comprising two or more iterative stages, wherein the problematic corner case corresponds to one of: both the numerator and denominator being 0, or both the numerator and denominator being infinity, and the fix-up operation comprises setting a reciprocal estimate of the denominator to be NaN in a first iterative stage such that the quotient of the Newton-Raphson division is computed as NaN.

14. The method of claim 1, wherein the computation is Newton-Raphson division of a numerator by a denominator, the Newton-Raphson division comprising two or more iterative stages, wherein the problematic corner case corresponds to one of: the denominator being 0, or the numerator being infinity and the denominator being a non-zero finite value, and the fix-up operation comprises setting the numerator to be infinity, setting the denominator to 1, and setting a reciprocal estimate of the denominator to be 1 in a first iterative stage such that the quotient of the Newton-Raphson division is computed as infinity.

15. The method of claim 1, wherein the computation is Newton-Raphson division of a numerator by a denominator, the Newton-Raphson division comprising two or more iterative stages, wherein at least one of the iterative stages comprises a fused multiply and add (FMA) operation on multiplier, multiplicand, and addend operands, wherein the problematic corner case corresponds to an expected error in a sign of a quotient of value 0, and wherein the fix-up operation comprises setting the sign of the result of the FMA operation to be the sign of the addend if either the multiplier or the multiplicand are of value 0.

16. The method of claim 1, wherein the computation is Newton-Raphson square root computation on a radicand, the Newton-Raphson square root computation comprising two or more iterative stages, wherein the fix-up operation comprises modifying computation of an error term in iterative inverse square root computation to implement a single fused multiply and add (FMA) operation in each iterative stage.

17. The method of claim 1, wherein the computation is Newton-Raphson square root computation on a radicand, the Newton-Raphson square root computation comprising two or more iterative stages, wherein the problematic corner case corresponds to a small radicand value expected to cause loss of precision and an inexact result, wherein the fix-up operation comprises applying a scaling factor of 2^{k} to the radicand, wherein k is a positive number.

18. The method of claim 17, further comprising applying a scaling factor of 2^{k/2} to the result of the Newton-Raphson square root computation.

19. The method of claim 1, wherein the computation is Newton-Raphson square root computation on a radicand, wherein the problematic corner case corresponds to the radicand being a NaN, and the fix-up operation comprises setting the result of the Newton-Raphson square root computation to NaN.

20. The method of claim 1, wherein the computation is Newton-Raphson square root computation on a radicand, wherein the problematic corner case corresponds to the radicand being a negative nonzero value, and the fix-up operation comprises setting the result of the Newton-Raphson square root computation to NaN.

21. The method of claim 1, wherein the computation is Newton-Raphson square root computation on a radicand, wherein the problematic corner case corresponds to the radicand being of value 0, and the fix-up operation comprises setting the result of the Newton-Raphson square root computation to a value 0 and of a same sign as that of the radicand.

22. The method of claim 1, wherein the computation is Newton-Raphson square root computation on a radicand, wherein the problematic corner case corresponds to the radicand being positive infinity, and the fix-up operation comprises setting the result of the Newton-Raphson square root computation to positive infinity.

23. A method of performing a floating point multiply accumulate (FMA) operation, the method comprising:
receiving, in a floating point unit, multiplier, multiplicand, and addend operands;
detecting that an FMA operation on the operands will generate an exception;
defining special conditions for the FMA operation;
suppressing error flags during the FMA operation; and
performing the FMA operation in the floating point unit according to the special conditions.

24. The method of claim 23, wherein the special conditions comprise defining a computation of infinity minus infinity to result in a zero value.

25. The method of claim 23, wherein the special conditions comprise forcing a rounding mode of the FMA operation to a round-to-nearest rounding mode.

26. The method of claim 23, wherein the special conditions comprise forcing the result of FMA operation to be equal to the value of the addend operand when the multiplicand operand is zero.

27. A method of performing a floating point multiply accumulate operation with scaling (FMASc), the method comprising:
receiving, in a floating point unit, multiplier, multiplicand, addend, and scaling factor operands;
detecting that an FMASc operation on the operands will generate an exception;
defining special conditions for the FMASc operation;
suppressing error flags during the FMASc operation; and
performing the FMASc operation in the floating point unit according to the special conditions.

28. The method of claim 27, wherein the special conditions comprise forcing the result of FMA operation to be equal to the value of the addend operand when the multiplicand operand is zero.

29. A floating point unit comprising:
logic to receive one or more floating point numbers and a floating point instruction corresponding to a computation;
detection logic configured to detect one or more floating point numbers that will generate a problematic corner case in the computation;
logic to suppress error flags during intermediate stages of the computation;
modification logic configured to modify the computation in order to avoid the problematic corner case; and
logic to the execute the modified computation.

30. The floating point unit of claim 29, integrated in at least one semiconductor die.

31. The floating point unit of claim 29, integrated into a device, selected from the group consisting of a set top box, music player, video player, entertainment unit, navigation device, communications device, personal digital assistant (PDA), fixed location data unit, and a computer.

32. A system comprising:
means for receiving one or more floating point numbers and a floating point instruction corresponding to a computation;
means for detecting one or more floating point numbers that will generate a problematic corner case in the computation;
means for suppressing error flags during intermediate stages of the computation;
means for modifying the computation in order to avoid the problematic corner case; and
means for executing the modified computation.

33. A non-transitory computer-readable storage medium comprising code, which, when executed by a processor, causes the processor to perform operations for performing a floating point computation, the non-transitory computer-readable storage medium comprising:
code for detecting one or more floating point numbers that will generate a problematic corner case in the computation;
code for suppressing error flags during intermediate stages of the computation;
code for modifying the computation with a fix-up operation in order to avoid the problematic corner case; and
code for performing the modified computation.
